(19) United States
(12) Patent Application Publication
(10) Pub. No.: US 2002/0010546 A1
(43) Pub. Date: Jan. 24, 2002

(54) Apparatus and method for determining the propagation velocity of an electromagnetic signal in a subsurface medium utilizing ground penetrating radar

(76) Inventor: Roger Roberts, Amesbury, MA (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 09/908,088

(22) Filed: Jul. 18, 2001

Related U.S. Application Data
(60) Provisional application No. 60/220,007, filed on Jul. 21, 2000.

(51) Int. Cl. G01V 3/00

(52) U.S. Cl. 702/2

(57) ABSTRACT

The present invention provides an apparatus and method for determining the propagation velocity of an electromagnetic signal in a subsurface medium which can then be utilized as a parameter in the calculations of various properties of a subsurface medium, including thickness, compaction and water content variation, and subsurface target depth. Propagation velocity is obtained by taking measurements in free space, resulting in air-launched waveforms, and at the medium surface, known as surface-coupled waveforms. The air-launched waveforms are subtracted from the surface-coupled waveforms resulting in a surface-coupled residual waveform. Comparison of the residual waveform amplitude to a calibrated amplitude scale obtained from measurements of media with known propagation velocities results in a velocity measurement comparable in regards to accuracy to a measurement obtained using the prior art.

### CROSS-REFERENCE TO RELATED APPLICATION

This application takes priority from U.S. patent application Ser. No. 60/220,007, filed on Jul. 21, 2000.

### FIELD OF THE INVENTION

This invention relates generally to an apparatus and method for determining the propagation velocity of an electromagnetic signal in a subsurface medium which can then be utilized as a parameter in the calculation of various properties of the subsurface medium and target.

### BACKGROUND OF THE INVENTION

Ground penetrating radar (“GPR”) systems are used to obtain measurements of subsurface structures and provide images of the internal structure of opaque materials such as soil, rock, concrete, asphalt and wood.

Most GPR equipment utilizes time-domain methods to penetrate the medium. This entails the generation and radiation of short electromagnetic pules in the range of 10 MHz to 2 GHz. The radiated pulses propagate from a system's radar transmitter and transmitter antenna, penetrate the subsurface medium and reflect, refract and/or diffract at boundaries of intrinsic impedance contrasts, commonly referred to as targets, in the subsurface. A portion of the redirected energy propagates back to a receiving antenna, where the energy is converted into voltage pulses that may be processed, displayed and stored. In this manner, a time versus distance map of a series of measurements over the medium surface can be constructed to provide a cross-sectional image of targets within the medium. This map can be converted to a depth versus distance map if the propagation velocity within the medium is known. Medium properties such as density and moisture content affect the velocity of an electromagnetic signal. The property which is used to describe the velocity of an electromagnetic signal in a material is called the dielectric constant. The amplitude of a reflected wave is, in the most general sense, a function of the contrast between the intrinsic impedance of the target and the intrinsic impedance of the surrounding material. The intrinsic impedance of a material is calculated from the conductivity, dielectric constant and magnetic permeability of the material. For many reflecting boundaries between two different materials commonly encountered by GPR users, the dielectric constant is the largest contributing facto to the intrinsic impedances of the materials and hence is also the largest contributing factor to the reflection coefficient at the boundary between the two materials. The propagation velocity in a medium may be calculated based upon the information obtained from the radiation and reception of the electromagnetic signal. In many cases, the propagation velocity within the medium varies too greatly to use an assumed propagation velocity and, therefore, it is difficult to obtain an accurate depth measurement.

Consequently, invasive techniques, such as physical extraction of a core, are commonly performed to establish the depth of an isolated intrinsic impedance contrast, which is then used to calculate the propagation velocity in the medium for depth conversion of the subsurface image. This is an expensive and inconvenient technique.

There are other alternative methods for velocity calculation using multiple target reflections obtained with different antenna distances relative to a target. However, these methods require certain assumptions to be made such as (1) negligible lateral velocity variation in the area of the measurement, (2) straight raypath propagation from the transmit antenna to the target and back to the receive antenna and (3) no movement in the reflection point as the antennas are repositioned at different distances from the target. Additionally, a buried target or subsurface interface must be present for this analysis.

Another prior art method commonly used in determining the propagation velocity in a medium using surface reflection waveforms involves the use of transmitting and receiving antennas placed at least one wavelength, corresponding to the center frequency, or greater from the medium surface. The antennas utilized in this method are specifically designed to be used at a distance of one wavelength or greater from the medium surface. Air-launched antennas are typically much larger than their ground-coupled counterparts and must be maintained at a relatively constant height and oriented parallel to the surface of the medium being analyzed.

The apparatus and method of the present invention utilizes antennas designed to be operated at 1/10th of a wavelength, corresponding to the center frequency, or less from the medium surface. These antennas are typically referred to as ground-coupled antennas. The benefits of the present invention include: (1) the ability to extract the propagation velocity from calibration data obtained with the use of at least one ground-coupled antenna after performing a simple calibration measurement and (2) the ability to obtain accurate propagation velocities calculated from data from a ground-coupled antenna, which are less sensitive to external noise because of inherent beam focusing associated with the near proximity of the medium.

### SUMMARY OF THE INVENTION

The present invention provides an apparatus and method for determining the propagation velocity of an electromagnetic signal in a subsurface medium which can then be utilized as a parameter in the calculations of various properties of the subsurface medium, including thickness, compaction and water content variation, and subsurface target depth. Propagation velocity is obtained by taking measurements in free space, resulting in air-launched waveforms, and at the medium surface, known as surface-coupled waveforms. The air-launched waveforms are subtracted from the surface-coupled waveforms resulting in a surface-coupled residual waveform. Comparison of the residual waveform amplitude to a calibrated amplitude scale obtained from measurements of media with known propagation velocities results in a velocity measurement comparable in regards to accuracy to a measurement obtained using the prior art.

Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 is a block diagram of the main components of a GPR system;

FIG. 2 illustrates placement of transmitting and receiving antennas at a select distance within an antenna enclosure;

FIG. 3 illustrates alternative antenna configurations used to obtain enhanced calculated velocities;

FIG. 4 is a graph of direct-coupling waveforms obtained from measurements taken in free space and with different media;

FIG. 5 is a graph of surface-coupled residual waveforms obtained from subtraction of the air-launched waveform, in FIG. 4, from the waveform obtained with the antenna in contact with the different media;

FIG. 6 is a plot illustrating relative amplitudes versus medium propagation velocity taken from six separate transmit-receive antenna pair possessing the same center frequency of approximately 1.5 GHz; and

FIG. 7 is a plot illustrating relative amplitudes versus medium propagation velocity taken from a transmit-receive antenna pair possessing the center frequency of approximately 400 MHz.

### DETAILED DESCRIPTION OF THE PREFERRED EMBODIMENT

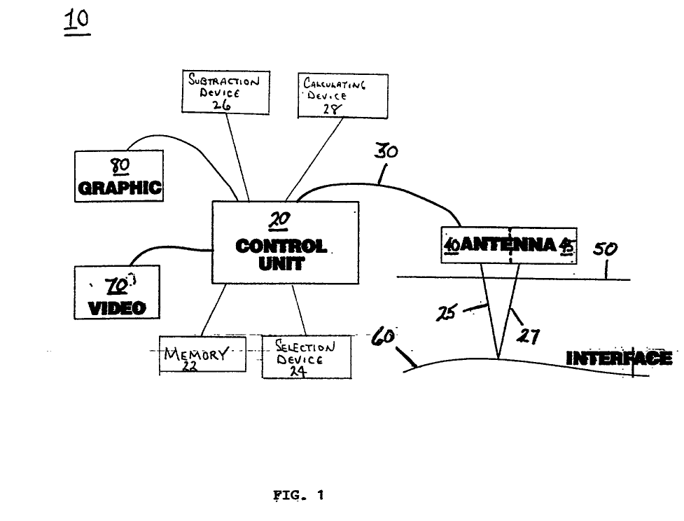

The present invention utilizes a GPR system 10, as shown in FIG. 1, comprising a control unit 20 wherein a signal or pulse is generated and transmitted via a cable 30 to a transmit antenna 40. The pulse 25 is transmitted from the transmit antenna 40, penetrates a medium 50 and is reflected at a subsurface interface 60. The reflected pulse 27 is received at a receive antenna 45 and is transmitted to the control unit 20 via cable 30, where the reflected pulse 27 may be stored in memory or displayed on a monitor 70 or graphic recorder 80.

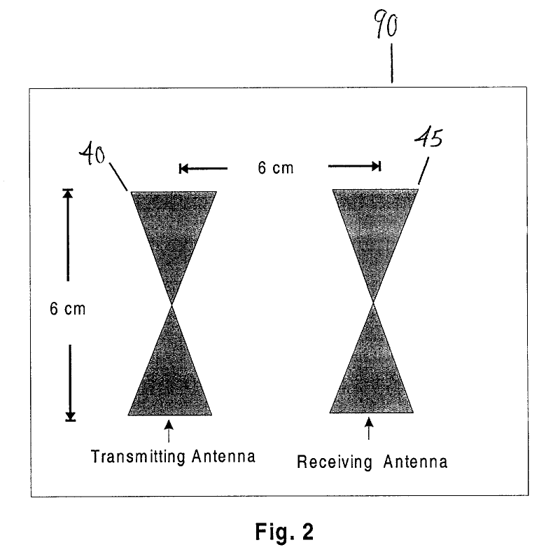

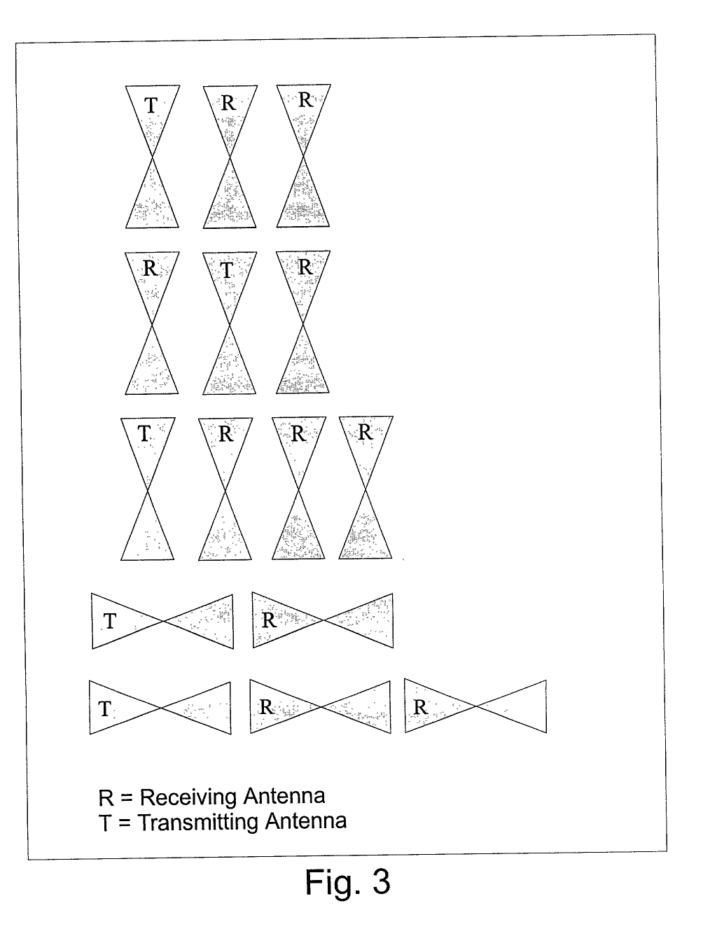

FIG. 1 illustrates the use of a single antenna in the radiation of pulse 25 and reception of pulse 27. As illustrated in FIGS. 2 and 3, separate transmitting and receiving antennas may also be used.

FIG. 2 illustrates the typical application of the present invention wherein a separate transmitting antenna 40 and receiving antenna 45 are placed parallel or substantially parallel to one another approximately ¼th to 1 wavelength, corresponding to the center frequency, apart in a common enclosure 90.

FIG. 3 illustrates other possible antenna configurations used to obtain enhanced calculated velocities.

In a preferred embodiment, a data measurement is obtained with the antenna placed in air and one or more measurements obtained with the antenna located at a distance of ¼th of a wavelength, or less, from the medium surface. The data measurements or electromagnetic waveforms are outputted to the control unit 20, which comprises a memory 22 for storing multiple electromagnetic waveforms and a selection device 24, coupled to the memory 22, for selecting at least one of the electromagnetic waveforms. The control unit 20 also includes a subtraction device 26 coupled to the selection device 24 for receiving the electromagnetic waveforms. The subtraction device 26 subtracts the electromagnetic waveform obtained from free space with the electromagnetic waveform reflected, refracted and/or diffracted from the medium surface, resulting in a residual waveform. A calculating device 28, in the control unit 20, coupled to the subtraction device 26 calculates the propagation velocity of the medium by comparing the residual waveform amplitude with a calibrated amplitude scale obtained from measurements of media with known propagation velocities. An electronic display device, for example, a CRT (cathode ray tube) assembly or monitor 70 or a graphic recorder 80, may be used to display the data indicative of the plurality of electromagnetic waveforms propagation velocity. The propagation velocity can also be utilized as a parameter in the calculations of various properties of a subsurface medium, including thickness, compaction and water content variation, and subsurface target depth.

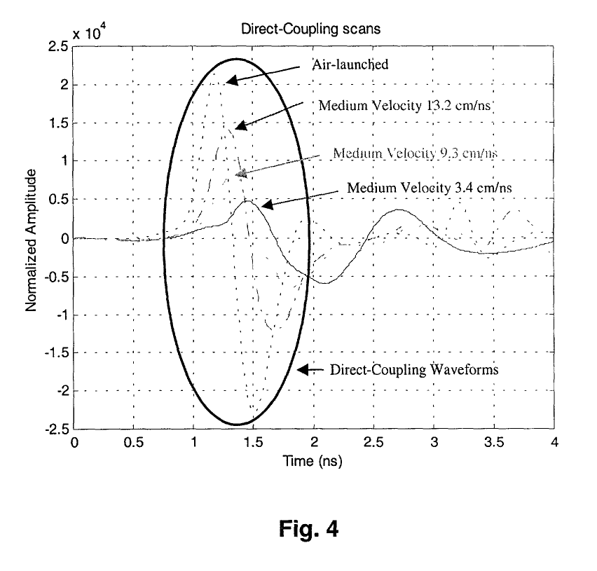

FIG. 4 illustrates the difference in the direct-coupling waveform obtained from measurements taken with the antenna enclosed in air versus in contact with various different media. The amplitude of the direct-coupling waveform, obtained with the antenna placed in close proximity with the medium surface, can be used to obtain the propagation velocity in the medium by comparing the amplitude of the direct-coupling waveform to a calibrated amplitude versus velocity curve obtained from measurements over a range of different media with known propagation velocities.

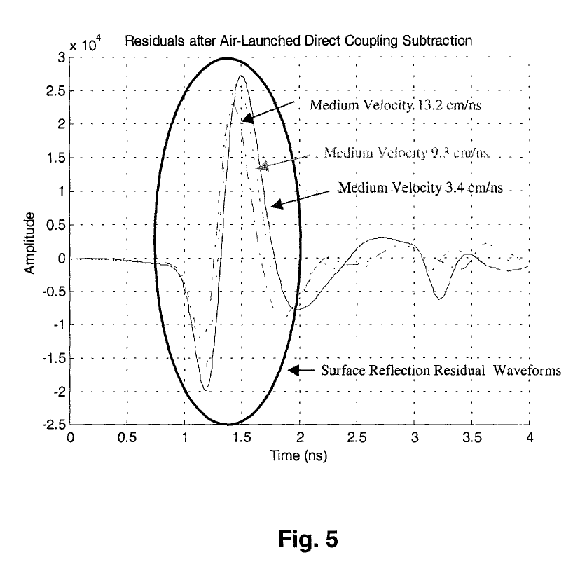

A major disadvantage in determining the propagation velocity using this approach is that the measurement of the direct-coupling waveform is very sensitive to the thickness of the medium when the medium thickness is on the order of ¼ of the propagation wavelength or less. A more reliable method is to perform a full waveform subtraction of the air-launched waveform from the direct-coupled waveform and use the first arriving negative peak amplitude of the resultant waveform to determine the propagation velocity. Typical resultant waveforms, known as surface-coupled residuals, are illustrated in the graph in FIG. 5. The propagation velocity for a given medium can be obtained by comparing the amplitude of the resultant waveform to a known amplitude versus velocity curve.

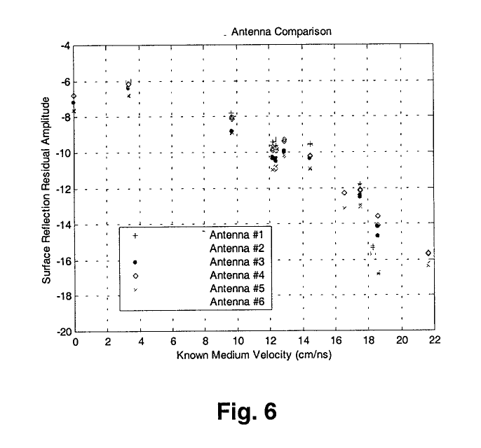

FIG. 6 is a plot illustrating relative amplitudes versus medium propagation velocity taken from six separate transmit-receive antenna pair possessing the same center frequency of approximately 1.5 GHz. Differences in the amplitude response between antenna pairs can be attributed to slight variations in the antenna construction and electrical components. The calibration measurements from the plot in FIG. 6 can be used to calculate the propagation velocities in unknown media by comparison of the amplitudes of the surface-coupled residuals from the unknown media with the amplitudes of the surface-coupled residuals in FIG. 6.

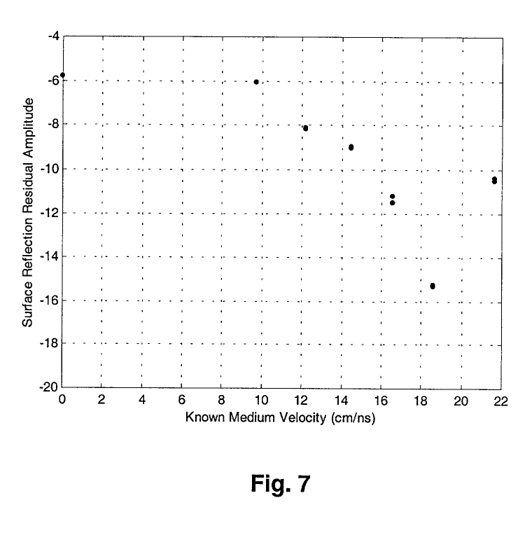

FIG. 7 is a plot illustrating relative amplitudes versus medium propagation velocity taken from a transmit-receive antenna pair possessing the center frequency of approximately 400 MHz. The lower frequency antenna data provide propagation velocities that are representative of the velocity structure of the medium over a larger depth range because the velocity structure to a depth of approximately ⅛th of the radiated wavelength is incorporated in the calculated propagation velocity.

The near surface interaction between the transmitting antenna and the medium results in the amplitude sensitivity which can be large in regard to slight changes in the transmit-receive antenna separation, distance of the antenna(s) from the medium surface and the antenna enclosure geometry.

Assumptions inherent with the success of this invention include: (1) minimal medium surface roughness relative to the radiated wavelength, and (2) a homogenous medium in regard to propagation velocity with increasing depth in the medium. The effect of surface roughness on the velocity calculated using the present invention has not been quantitatively measured. The fact that the first negative peak of the surface-coupled residual is used as the amplitude reference for velocity calculation means that the velocities of layers as thin as approximately ⅛th of a radiated wavelength can be accurately measured. Conversely, if the near-surface of a medium possesses slightly different electromagnetic properties than the rest of the medium, then the calculated velocity using the surface-coupled residual will not provide the best mean velocity value for the medium. In practice, it would be advantageous to use the lowest frequency antenna that can practically be used, taking into account the thickness of the surface layer and providing that the surface layer is not significantly dispersive, for velocity calculation to (1) minimize the effects of surface roughness and (2) minimize the effects of near-surface velocity variations.

The foregoing description is directed to particular embodiments of the present invention for the purpose of illustration and explanation. It will be apparent, however, to one skilled in the art that many modifications and changes to the embodiment set forth are possible without departing from the scope and the spirit of the invention. It is intended that the following claims be interpreted to embrace all such modifications and changes.

What is claimed is:

1. A method of determining a propagation velocity of an electromagnetic signal in a medium, comprising:
(a) placing at least one antenna in free space;
(b) radiating a first signal from said at least one antenna into free space;
(c) measuring at least one parameter of said first signal upon detection at said at least one antenna;
(d) placing said at least one antenna over said medium;
(e) radiating a second signal from said at least one antenna into said medium;
(f) measuring at least one parameter of a said second signal upon detection at said at least one antenna; and
(g) utilizing measurement of said at least one parameter from said first signal and measurement of said at least one parameter from said second signal and calculating the propagation velocity of said medium.

2. The method of claim 1, wherein said propagation velocity may be used as a parameter in calculating various subsurface medium properties.

3. The method of claim 2, wherein said calculating various subsurface medium properties includes calculating a medium thickness.

4. The method of claim 2, wherein said calculating various subsurface medium properties includes calculating a medium compaction.

5. The method of claim 2, wherein said calculating various subsurface medium properties includes calculating a medium water content variation.

6. The method of claim 2, wherein said calculating various subsurface medium properties includes calculating a medium depth.

7. A method of determining a propagation velocity of an electromagnetic waveform though a medium, comprising:
(a) generating a first electromagnetic waveform from a control unit;
(b) outputting said first electromagnetic waveform from said control unit to a first antenna;
(c) transmitting said first electromagnetic waveform from said first antenna into free space;
(d) receiving said first electromagnetic waveform at a second antenna;
(e) outputting said first electromagnetic waveform received at said second antenna to said control unit;
(f) storing said first electromagnetic waveform in said control unit;
(g) placing said first antenna and said second antenna up to and including a distance ¼th of the center frequency wavelength from a surface of said medium;
(h) generating a second electromagnetic waveform from said control unit;
(i) outputting said second electromagnetic waveform from said control unit to said first antenna;
(j) transmitting said second electromagnetic waveform from said first antenna to said medium surface;
(k) receiving said second electromagnetic waveform at said second antenna;
(l) outputting said second electromagnetic waveform received at said second antenna to said control unit;
(m) subtracting said first electromagnetic waveform received at said second antenna from said second electromagnetic waveform received at said second antenna thereby resulting in a residual waveform; and
(n) from a calibrated amplitude scale representative of a plurality of measurements of media with known propagation velocities stored in said control unit, calculating the propagation velocity of said medium by comparing an amplitude of said residual waveform to said calibrated amplitude scale.

8. A method of determining a propagation velocity of an electromagnetic waveform though a medium, comprising:
(a) generating a first electromagnetic waveform from a control unit;
(b) outputting said first electromagnetic waveform from said control unit to an antenna;
(c) transmitting said first electromagnetic waveform from said antenna into free space;
(d) receiving said first electromagnetic waveform from at said antenna;
(e) outputting said first electromagnetic waveform from said antenna to said control unit;
(f) storing said first electromagnetic waveform in said control unit;
(g) placing said antenna up to and including a distance ¼th of the center frequency wavelength from a surface of said medium;
(h) generating a second electromagnetic waveform from said control unit;
(i) outputting said second electromagnetic waveform from said control unit to said antenna;
(j) transmitting said second electromagnetic waveform from said antenna to said medium surface;
(k) receiving said second electromagnetic waveform at said antenna;
(l) outputting said second electromagnetic waveform received at said antenna to said control unit;
(m) subtracting said first electromagnetic waveform received at said antenna from said second electromagnetic waveform received at said antenna thereby resulting in a residual waveform; and
(n) from a calibrated amplitude scale representative of a plurality of measurements of media with known propagation velocities stored in said control unit, calculating the propagation velocity of said medium by comparing an amplitude of said residual waveform to said calibrated amplitude scale.

9. An apparatus for determining a propagation velocity of an electromagnetic waveform though a medium, comprising:
(a) a control unit for generating a plurality of electromagnetic waveforms, said control unit comprising:
(i) a memory for storing said plurality of electromagnetic waveforms;
(ii) a selection device coupled to said memory and capable of selecting at least one of said plurality of electromagnetic waveforms;
(iii) a subtraction device coupled to said selection device for receipt of said plurality of electromagnetic waveforms, said subtraction device capable of subtracting a first electromagnetic waveform of said plurality of electromagnetic waveforms from a second electromagnetic waveform of said plurality of electromagnetic waveforms;
(iv) a calculating device coupled to said subtraction device for calculating the propagation velocity of said medium; and
(b) at least one antenna acting cooperatively with said control unit for transmission and receipt of said plurality of electromagnetic waveforms.

10. The apparatus of claim 9, wherein said propagation velocity may be used as a parameter in calculating various subsurface medium properties.

11. The apparatus of claim 10, wherein said various subsurface medium properties includes a medium thickness.

12. The apparatus of claim 10, wherein said various subsurface medium properties includes a medium compaction.

13. The apparatus of claim 10, wherein said various subsurface medium properties includes a medium water content variation.

14. The apparatus of claim 10, wherein said various subsurface medium properties includes a medium depth.

15. The apparatus of claim 9, wherein said at least one antenna is a ground coupled antenna.

16. The apparatus of claim 9, further comprising a display device for displaying data indicative of said plurality of electromagnetic waveforms.

17. An apparatus for determining a propagation velocity of an electromagnetic waveform though a medium, comprising:
(a) a control unit for generating a plurality of electromagnetic waveforms, said control unit comprising:
(i) a memory for storing said plurality of electromagnetic waveforms;
(ii) a selection device coupled to said memory and capable of selecting at least one of said plurality of electromagnetic waveforms;
(iii) a subtraction device coupled to said selection device for receipt of said plurality of electromagnetic waveforms, said subtraction device capable of subtracting a first electromagnetic waveform of said plurality of electromagnetic waveforms from a second electromagnetic waveform of said plurality of electromagnetic waveforms;
(iv) a calculating device coupled to said subtraction device for calculating the propagation velocity of said medium; and
(b) a plurality of antenna acting cooperatively with said control unit for transmission and receipt of said plurality of electromagnetic waveforms.

18. The apparatus of claim 17, wherein said plurality of antenna comprise ground coupled antennas.

19. The apparatus of claim 17, further comprising a display device for displaying data indicative of said plurality of electromagnetic waveforms.
